(19) United States
(12) Patent Application Publication
(10) Pub. No.: US 2019/0286561 A1
(43) Pub. Date: Sep. 19, 2019

(54) MEMORY SYSTEM AND OPERATION METHOD THEREOF

(71) Applicant: SK hynix Inc., Gyeonggi-do (KR)

(72) Inventors: Jong-Min Lee, Seoul (KR); Beom-Rae Jeong, Gyeonggi-do (KR)

(21) Appl. No.: 16/180,891

(22) Filed: Nov. 5, 2018

(30) Foreign Application Priority Data
Mar. 15, 2018 (KR) 10-2018-0030273

(51) Int. Cl. G06F 12/0804

(52) U.S. Cl. CPC G06F 12/0804; G06F 2212/1008; G06F 2212/608; G06F 2212/603; G06F 2212/205

(57) ABSTRACT

A memory system may include: a nonvolatile memory device, a volatile memory device, a free exclusive mode flag configured to correspond to an entrance/exit state of a free exclusive mode, a host controller configured to process a first operation with the host and delay a process of the first operation in an entrance period of the free exclusive mode which is knowable by checking a value of the free exclusive flag, and a memory controller configured to process a second operation with the nonvolatile memory device, set the value of the free exclusive flag in response to a result of checking a state of the nonvolatile memory device, and exclusively use the volatile memory device so as to process a merge operation in the second operation in the entrance period of the free exclusive mode that is knowable by checking the value of the free exclusive flag.

### CROSS-REFERENCE TO RELATED APPLICATION

This application claims priority under 35 U.S.C. § 119 to Korean Patent Application No. 10-2018-0030273 filed on Mar. 15, 2018, which is incorporated herein by reference in its entirety.

### BACKGROUND

### 1. Field

Various embodiments of the present invention generally relate to a memory system. Particularly, the embodiments relate to a memory system supporting a merge operation and an operation method thereof.

### 2. Discussion of the Related Art

The computer environment paradigm has changed to ubiquitous computing systems that can be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSD).

### SUMMARY

Various embodiments are directed to a memory system capable of maximizing performance of a merge operation, and an operation method thereof.

In an embodiment, a memory system may include: a nonvolatile memory device comprising a plurality of memory blocks, each of which comprises a plurality of pages; a volatile memory device configured to temporarily store data to be delivered between a host and the nonvolatile memory device; a host controller configured to process a first operation with the host and delay the process of the first operation in a free exclusive mode according to a value of a free exclusive flag indicating the free exclusive mode; and a memory controller configured to process a second operation with the nonvolatile memory device, set the value of the free exclusive flag according to a state of the nonvolatile memory device, and exclusively use the volatile memory device so as to process a merge operation in the second operation in the free exclusive mode.

The memory controller may check a ratio of free memory blocks among the memory blocks, the memory controller may set the free exclusive flag to indicate the free exclusive mode when a checked result is equal to or smaller than a set ratio, and the memory controller may set the free exclusive flag to indicate a mode other than the free exclusive mode when the checked result is greater than the set ratio.

The memory controller may check a number of entire valid pages included in victim memory blocks among the memory blocks when performing the merge operation, the memory controller may set the free exclusive flag to indicate the free exclusive mode when a checked result is equal to or smaller than a set number, and the memory controller may set the free exclusive flag to indicate a mode other than the free exclusive mode when the checked result is greater than the set number.

The memory controller may set the free exclusive flag to the indicate the free exclusive mode each time the merge operation is performed, and the memory controller may set the free exclusive flag to indicate a mode other than the free exclusive mode each time an operation other than the merge operation is performed in the second operation.

The host controller may notify the host of a busy state in the free exclusive mode, and may notify the host of a ready state in a mode other than the free exclusive mode.

The host controller may include a command queue configured to store commands delivered from the host, and the host controller may delay a process of the commands delivered from the host and stored in the command queue in the free exclusive mode.

The host controller may store the commands delivered from the host in free exclusive mode in the command queue and then delivers, to the host, a response indicating process completion of the commands after exit from free exclusive mode by delaying delivering the stored commands to the memory controller until the exit from the free exclusive mode.

The host controller may delay delivering, to the host, a response indicating transmission completion of write commands until the exit from the free exclusive mode, or may retrieve write data stored in an internal memory of the host in response to the write commands after the exit from the free exclusive mode, so as to delay transmission of the write data corresponding to each of the write commands from the host among the commands stored in the command queue in the free exclusive mode until the exit from the free exclusive mode.

The memory controller may flush the data stored in the volatile memory device to the nonvolatile memory device in the free exclusive mode, and then exclusively uses the volatile memory device so as to perform the merge operation for the nonvolatile memory device in the free exclusive mode.

The memory controller may convert, to a discard state, data updated to the nonvolatile memory device among data stored in the volatile memory device in the free exclusive mode, and the memory controller may exclusively use the volatile memory device so as to perform the merge operation for the nonvolatile memory device in the free exclusive mode.

In an embodiment, an operation method of a memory system including a nonvolatile memory device comprising a plurality of memory blocks, each of which comprises a plurality of pages, a volatile memory device configured to temporarily store data to be delivered between a host and the nonvolatile memory device, a host controller configured to process a first operation with the host, and a memory controller configured to process a second operation with the nonvolatile memory device, the operation method may include: a delay operation of checking a value of a free exclusive flag indicating a free exclusive mode through the host controller and then delaying the process of the first operation through the host controller in the free exclusive mode according to the value of the free exclusive flag; a setting operation of setting the value of the free exclusive flag through the memory controller according to a state of the nonvolatile memory device; and a using operation of exclusively using the volatile memory device so as to process a merge operation in the second operation through the memory controller in the free exclusive mode.

The setting operation may include: a first checking operation of checking a ratio of free memory blocks among the memory blocks through the memory controller; an operation of setting the free exclusive flag to indicate the free exclusive mode through the memory controller when a checked result is equal to or smaller than a set ratio; and an operation of setting the free exclusive flag to indicate a mode other than the free exclusive mode through the memory controller when the checked result is greater than the set ratio.

The setting operation may include: a second checking operation of checking a number of entire valid pages comprised in victim memory blocks among the memory blocks when the merge operation is performed through the memory controller; an operation of setting the free exclusive flag to indicate the free exclusive mode through the memory controller when a checked result is equal to or greater than a set number; and an operation of setting the free exclusive flag to indicate a mode other than the free exclusive mode through the memory controller when the checked result is smaller than the set number.

The setting operation may include: an operation of setting the free exclusive flag to indicate the free exclusive mode, each time the merge operation is performed through the memory controller; and an operation of setting the free exclusive flag to indicate a mode other than the free exclusive mode, each time an operation other than the merge operation is performed in the second operation through the memory controller.

The delaying operation may include: a third checking operation of checking the value of the free exclusive flag through the host controller; an operation of notifying, by the host controller, the host that the memory system is busy in the free exclusive mode; and an operation of notifying, by the host controller, the host that the memory system is ready in the free exclusive mode.

The delaying operation may include: a fourth checking operation of checking the value of the free exclusive flag through the host controller comprising a command queue configured to store commands delivered from the host; and a command delaying operation of delaying a process of the host controller for the commands delivered from the host and stored in the command queue in the free exclusive mode.

The command delaying operation may include: an operation of storing, by the host controller, the commands delivered from the host in the command queue therein in the free exclusive mode; and an operation of delivering, from the host controller to the host, a response indicating process completion of the commands after an exit from the free exclusive mode by delaying, by the host controller, delivering the commands stored in the command queue to the memory controller until the exit from the free exclusive mode.

The command delaying operation may further include: an operation of delaying delivering, to the host from the host controller, a response indicating transmission completion of write commands until the exit from the free exclusive mode exit time; or an operation of retrieving, from the host controller, write data stored in an internal memory of the host in response to the write commands after the exit from the free exclusive mode, so as to delay transmission, from the host to the host controller, of the write data corresponding to each of the write commands among the commands stored in the command queue in the free exclusive mode until the exit from the free exclusive mode through the storing operation.

The using operation may include: a fifth checking operation of checking the value of the free exclusive flag through the memory controller; an operation of flushing the data stored in the volatile memory device to the nonvolatile memory device through the memory controller in the free exclusive mode; and an operation of exclusively using the volatile memory device so as to perform the merge operation for the nonvolatile memory device in the free exclusive mode.

the using operation may include: a sixth checking operation of checking the value of the free exclusive flag through the memory controller; an operation of converting, to a discard state, data updated to the nonvolatile memory device among the data stored in the volatile memory device through the memory controller in the free exclusive mode which is knowable from the sixth checking operation; and an operation of exclusively using the volatile memory device so as to perform the merge operation for the nonvolatile memory device in the free exclusive mode.

In an embodiment, a memory system may include: a memory device including memory blocks; a working memory configured to temporarily store data to be transferred between a host and the memory device; and a controller configured to: queue a request provided from the host; and control the memory device to perform a foreground operation to the memory blocks by providing a command corresponding to the queued request to the memory device, the controller may set or may release a free exclusive flag according to a state of the memory device, the controller may control the memory device to perform a merge operation in a free exclusive mode by exclusively using the working memory after flushing the temporarily stored data, the controller may delay providing the host with a response to the request by delaying the foreground operation or by delaying the providing of the command in the free exclusive mode, and the memory device may become busy in the free exclusive mode according to the set free exclusive flag.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system in accordance with an embodiment of the present invention;

FIG. 2 is a schematic diagram illustrating an exemplary configuration of a memory device employed in the memory system shown in FIG. 1;

FIG. 3 is a circuit diagram illustrating an exemplary configuration of a memory cell array of a memory block in the memory device shown in FIG. 2;

FIG. 4 is a schematic diagram illustrating an exemplary three-dimensional structure of the memory device shown in FIG. 2;

FIGS. 5 to 7 are diagrams explaining a memory system according to embodiments of the invention;

FIGS. 8 to 16 are diagrams schematically illustrating application examples of the data processing system shown in FIG. 1 in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention. It is noted that reference to “an embodiment” does not necessarily mean only one embodiment, and different references to “an embodiment” are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

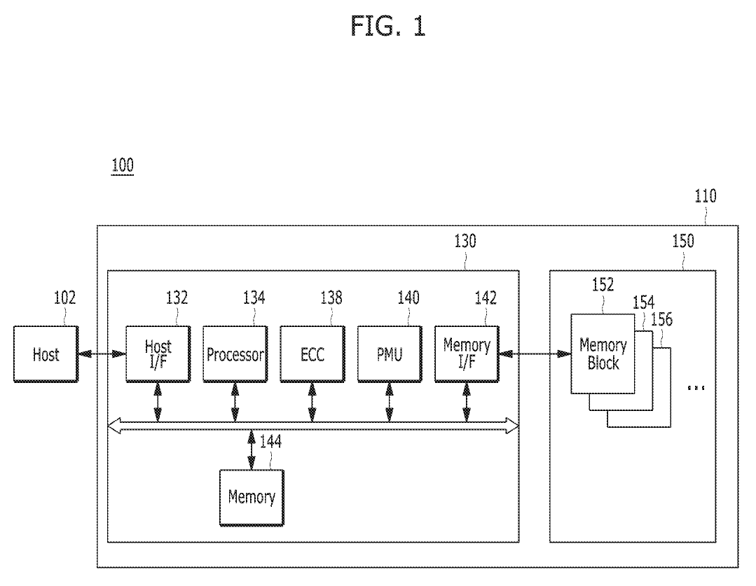

FIG. 1 is a block diagram illustrating a data processing system 100 including a memory system 110 in accordance with an embodiment of the present invention.

Referring to FIG. 1, the data processing system 100 may include a host 102 and the memory system 110.

The host 102 may include portable electronic devices such as a mobile phone, MP3 player and laptop computer or non-portable electronic devices such as a desktop computer, game machine, TV and projector.

The memory system 110 may operate to store data for the host 102 in response to a request of the host 102. Non-limiting examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may be embodied by various types of storage devices. Non-limiting examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The flash memory may have a 2-dimensional (2D) or a 3-dimensional (3D) stack structure.

The memory system 110 may include a memory device 150 and a controller 130. The memory device 150 may store data for the host 120, and the controller 130 may control data storage into the memory device 150.

The controller 130 and the memory device 150 may be integrated into a single semiconductor device, which may be included in the various types of memory systems as exemplified above.

Non-limiting application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies (not shown). Each memory die may include a plurality of planes (not shown). Each plane may include a plurality of memory blocks 152 to 156. Each of the memory blocks 152 to 156 may include a plurality of pages. Each of the pages may include a plurality of memory cells coupled to a word line.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) 132, a processor 134, an error correction code (ECC) 138, a Power Management Unit (PMU) 140, a memory interface 142 such as a NAND flash controller (NFC), and a memory 144 all operatively coupled via an internal bus.

The host interface 132 may be configured to process a command and data of the host 102, and may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (DATA), enhanced small disk interface (ESDI) and integrated drive electronics (IDE).

The ECC 138 may detect and correct an error contained in the data read from the memory device 150. In other words, the ECC 138 may perform an error correction decoding process to the data read from the memory device 150 through an ECC code used during an ECC encoding process. According to a result of the error correction decoding process, the ECC 138 may output a signal, for example, an error correction success/fail signal. When the number of error bits is more than a threshold value of correctable error bits, the ECC 138 may not correct the error bits, and may output an error correction fail signal.

The ECC 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC 138 is not limited thereto. The ECC 138 may include all circuits, modules, systems or devices for error correction.

The PMU 140 may provide and manage power of the controller 130.

The memory interface 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory interface 142 may generate a control signal for the memory device 150 and process data to be provided to the memory device 150 under the control of the processor 134. The memory interface 142 may work as an interface (e.g., a NAND flash interface) for processing a command and data between the controller 130 and the memory device 150. Specifically, the memory interface 142 may support data transfer between the controller 130 and the memory device 150.

The memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

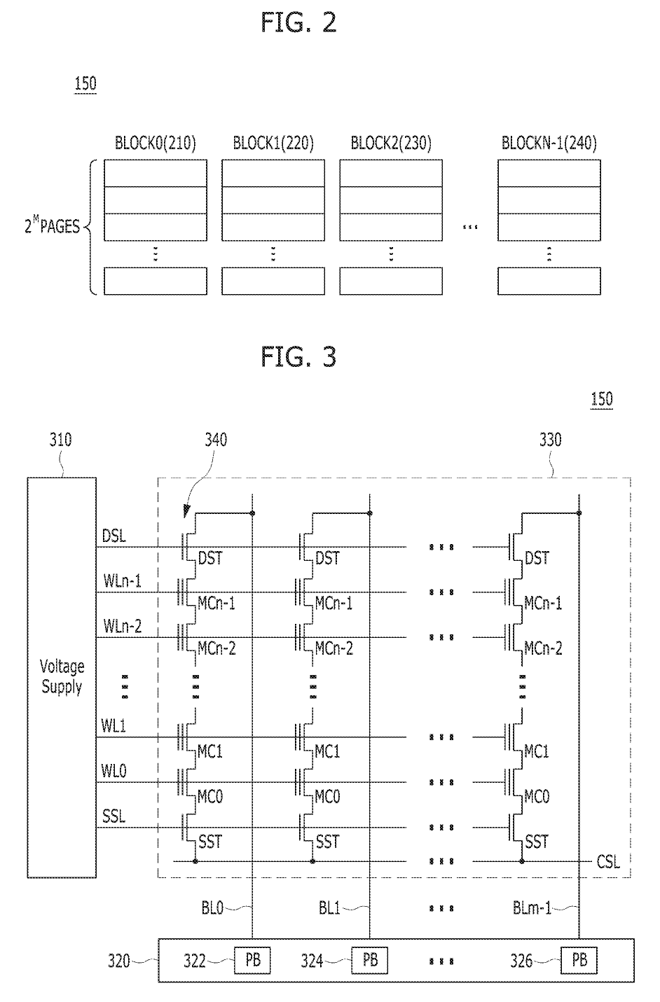

FIG. 2 is a schematic diagram illustrating the memory device 150.

Referring to FIG. 2, the memory device 150 may include a plurality of memory blocks BLOCK0 to BLOCKN−1, and each of the memory blocks BLOCK0 to BLOCKN−1 may include a plurality of pages, for example, 2^{M} pages, the number of which may vary according to circuit design. Memory cells included in the respective memory blocks BLOCK0 to BLOCKN−1 may be one or more of a single level cell (SLC) storing 1-bit data, or a multi-level cell (MLC) storing 2- or more bit data. In an embodiment, the memory device 150 may include a plurality of triple level cells (TLC) each storing 3-bit data. In another embodiment, the memory device may include a plurality of quadruple level cells (QLC) each storing 4-bit level cell.

FIG. 3 is a circuit diagram illustrating an exemplary configuration of a memory cell array of a memory block in the memory device 150.

Referring to FIG. 3, a memory block 330, which may correspond to any of the plurality of memory blocks 152 to 156 included in the memory device 150 of the memory system 110 shown in FIG. 1, may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1. For reference, in FIG. 3, ‘DSL’ denotes a drain select line, ‘SSL’ denotes a source select line, and ‘CSL’ denotes a common source line. A plurality of world lines WL0 to WLn−1 may be coupled in series between the select source line SSL and the drain source line DSL.

Although FIG. 3 illustrates NAND flash memory cells, the present invention is not limited thereto. That is, the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from a certain memory cell array of the memory block 330. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers (PBs) 322 to 326 respectively corresponding to columns (or bit lines) or column pairs (or bit line pairs). Each of the page buffers 322 to 326 may include a plurality of latches (not illustrated).

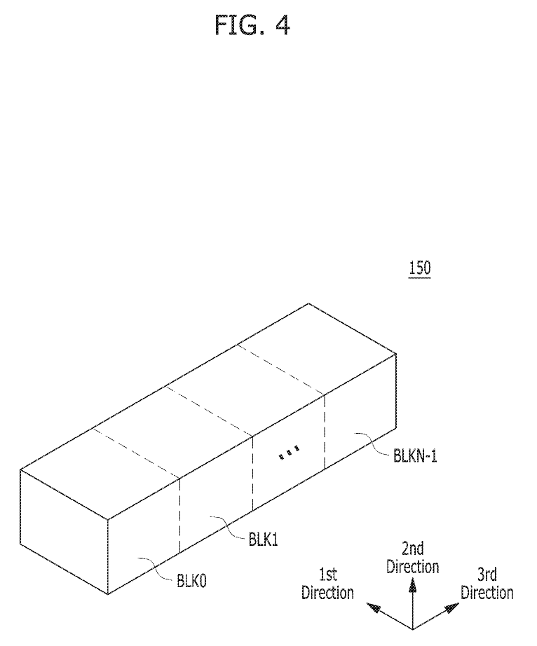

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure).

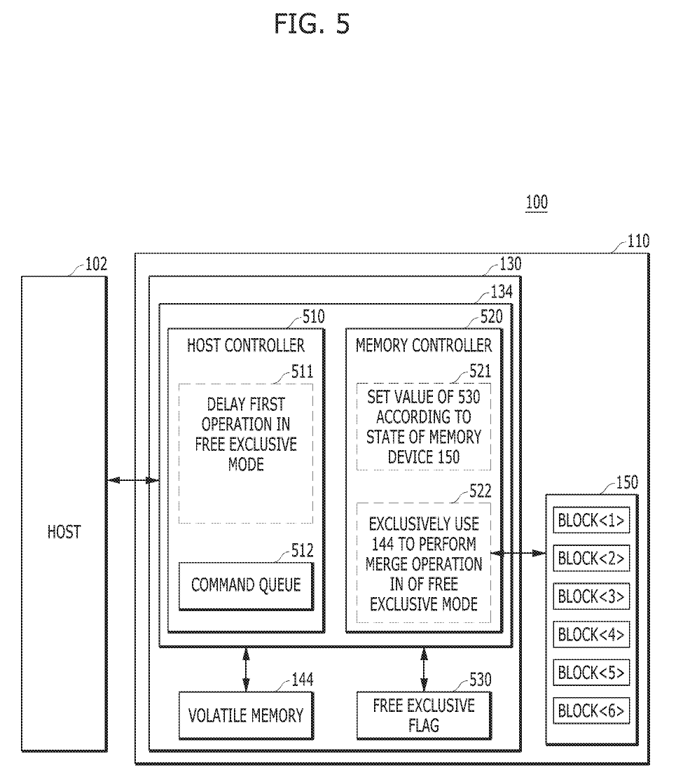

Hereinbelow, detailed descriptions will be made with reference to FIGS. 5 to 8, for data processing with respect to the memory device 150 in a memory system in accordance with an embodiment, particularly, a data processing operation in the case of performing a command operation corresponding to a command received from the host 102 and a data management operation.

FIGS. 5 to 7 are diagrams explaining an operation of a memory system according to embodiments of the present invention.

First, referring to FIGS. 5 to 7, a configuration of a data processing system 100 including a host 102 and a memory system 110 is illustrated with reference to a configuration of the data processing system 100 illustrated in FIG. 1.

Here, as described in relation to FIG. 1, the memory system 110 may include a controller 130 and a nonvolatile memory device 150.

In addition, the controller 130 may include a processor 134, a volatile memory device 144, and a free exclusive flag component 530. The free exclusive flag component 530 may store a free exclusive flag. Furthermore, the processor 134 may include a host controller 510 and a memory controller 520.

In addition, the nonvolatile memory device 150 may include a plurality of memory blocks BLOCK<1> to BLOCK<6>. The memory blocks BLOCK<1> to BLOCK<6> may correspond to the memory blocks 152 to 156 shown in FIG. 1. Here, each of the memory blocks BLOCK<1> to BLOCK<6> may include a plurality of pages as described in relation to FIG. 2.

Although FIGS. 5 to 7 illustrate a configuration in which the memory system 110 only includes one nonvolatile memory device 150, it is to be noted that this is merely only for convenience of description. That is, number of nonvolatile memory devices may be greater than one and may vary depending on design. In addition, although FIGS. 5 to 7 illustrate a configuration in which the nonvolatile memory device 150 includes six memory blocks BLOCK<1> to BLOCK<6>, it is to be noted that this is merely only for convenience of explanation. That is, number of nonvolatile memory blocks may be greater or less than six, and may vary depending on design.

In addition, the host interface 132, ECC 138, power management unit 140, and memory interface 142, which are included in the controller 130 illustrated in FIG. 1, are not illustrated in the controller 130 of FIGS. 5 to 7. However, the host interface 132, ECC 138, power management unit 140, and memory interface 142 are omitted only for convenience of explanation. The host interface 132, ECC 138, power management unit 140, and memory interface 142 may be included in the controller 130 according to an embodiment of the present invention.

Referring to FIG. 5, the nonvolatile memory device 150 may include a plurality of memory blocks BLOCK<1> to BLOCK<6>, each of which includes a plurality of pages (not shown).

In addition, the volatile memory device 144 temporarily stores data delivered between the host 102 and the nonvolatile memory device 150. Here, the volatile memory device 144 may correspond to the memory 144 of FIG. 1, and may be included in the controller 130. However, although FIG. 5 shows the volatile memory device 144 included in the controller 130, the present invention is not limited thereto. That is, the volatile memory device 144 may be outside the controller 130 in the memory system 110.

Furthermore, the free exclusive flag of the free exclusive flag component 530 may correspond to an entrance into or an exit from the free exclusive mode. In other words, a value of the free exclusive flag component 530 may be set to a value indicating an entrance state of the free exclusive mode, or a value indicating an exit state of the free exclusive mode.

The host controller 510 may process a first operation with the host 102.

The host controller 510 may delay a process of the first operation between the host controller 510 and the host 102 in the free exclusive mode, which may be known by checking the value of the free exclusive flag of the free exclusive flag component 530 (operation 511).

In addition, the host controller 510 may include a command queue 512 for storing commands delivered from the host 102. For example, the command queue 512 included in the host controller 510 may store write commands and read commands, etc., delivered from the host 102 up to a set number.

The memory controller 520 may be connected to the host controller 510 and may process a second operation with the nonvolatile memory device 150.

The memory controller 520 may set the value of the free exclusive flag of the free exclusive flag component 530 in response to a result obtained by checking a state of the nonvolatile memory device 150 (operation 521).

In addition, the memory controller 520 exclusively uses the volatile memory device 144 in order to process a merge operation in the second operation performed between the memory controller 502 and the nonvolatile memory device 150 in the free exclusive mode, which may be known by checking the value of the free exclusive flag of the free exclusive flag component 530 (operation 522).

The merge operation may include an operation of merging valid data included in two or more victim memory blocks among the memory blocks BLOCK<1> to BLOCK<6> in the nonvolatile memory 150, and an operation of moving the merged data to a target memory block.

For example, the merge operation may include or be a part of a garbage collection operation, a read reclaim operation, a wear leveling operation or a map update operation.

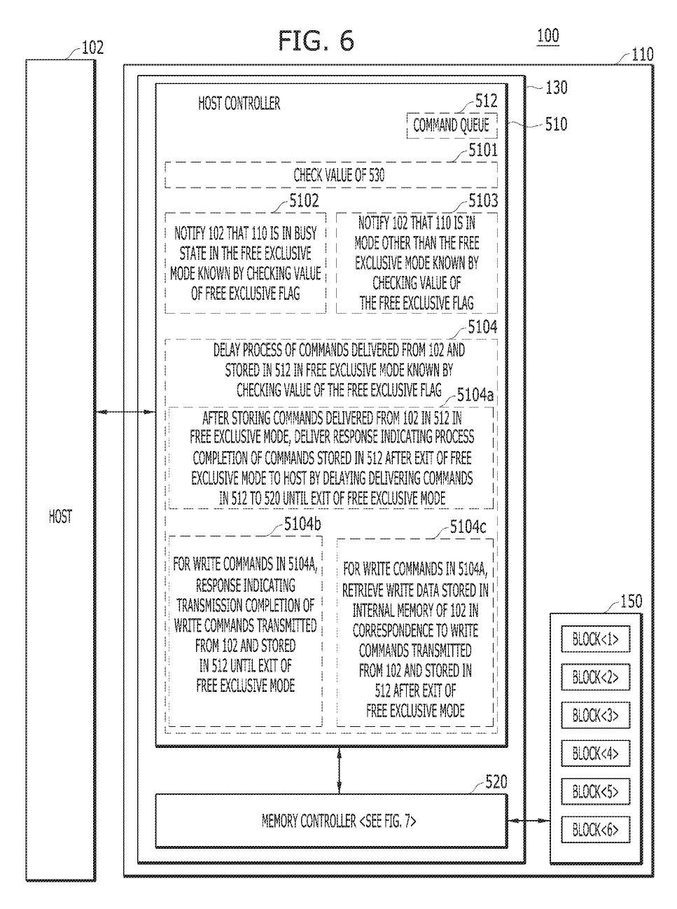

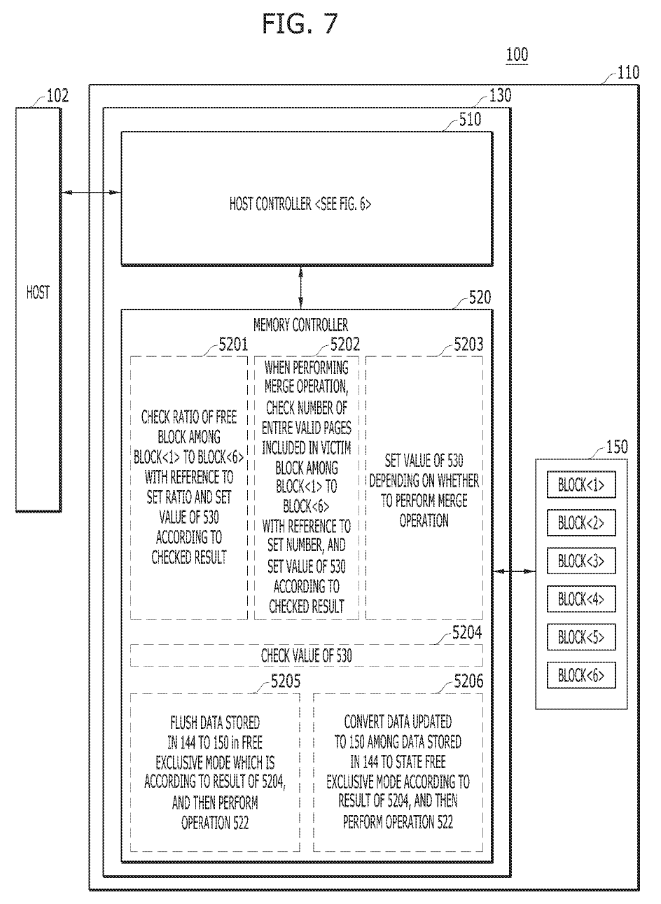

The above-described operation of the host controller 510 may be further described in more detail through FIG. 6 described below, and the above-described operation of the memory controller 520 may be further described in more detail through FIG. 7 described below.

Referring to FIG. 6, the host controller 510 may check the value of the free exclusive flag of the free exclusive flag component 530 (operation 5101). Here, the host controller 510 may only check the value of the free exclusive flag of the free exclusive flag component 530 through operation 5101, and may not set the value of the free exclusive flag of the free exclusive flag component 530.

The host controller 510 may delay the process of the first operation between the host controller 510 and the host 102 in the free exclusive mode as described in operation 511.

Here, an operation in which the host controller 510 delays the process of the first operation between the host controller 510 and the host 102 in the free exclusive mode may be largely divided into the following two schemes.

The first scheme is a scheme of controlling the host 102 not to request the host controller 510 to perform the first operation in the free exclusive mode, which may be known through the result of operation 5101, and instead controlling the host 102 to request the host controller 510 to perform the first operation in a mode other than the free exclusive mode.

For the first scheme, the host controller 510 may convert the state of the memory system 110 to a busy state in the free exclusive mode, which may be known by checking the value of the free exclusive flag of the free exclusive flag component 530 through operation 5101, and then notifies the busy state of the memory system 110 to the host 102 through operation 5102.

In this way, since the host 102 knows that the memory system 110 is in the busy state through the operation of the host controller 510 according to operation 5102, the host controller 510 may not receive a request to process the first operation, for example, a read or write operation, etc., from the host 102 in the free exclusive mode.

On the contrary, the host controller 510 may convert the state of the memory system 110 to a ready state in a mode other than the free exclusive mode, which may be known by checking the value of the free exclusive flag of the free exclusive flag component 530 through operation 5101, and then notifies the ready state of the memory system 110 to the host 102 through operation 5103.

In this way, since the host 102 knows that the memory system 110 is in the ready state through the operation of the host controller 510 according to operation 5103, the host controller 510 may receive a request to process the first operation, for example, the read or write operation, etc., from the host after exiting from the free exclusive mode.

The second scheme is a scheme of delaying a process of a command that is delivered from the host 102 in the free exclusive mode that may be known through the result of operation 5101, and is stored in the command queue 512 included in the host controller 510 through operation 5104.

For the second scheme, the host controller 510 may store the commands, which are delivered from the host 102 in the free exclusive mode that may be known through operation 5101, in the command queue 512, and then delivers to the host 102 a response indicating process completion of the commands provided from the host 102 after exit of the free exclusive mode by delaying delivering the commands stored in the command queue 512 to the memory controller 520 until the exit from the free exclusive mode through operation 5104a.

In other words, since the host controller 510 delivers the commands stored in the command queue 512 to the memory controller 520 after exiting from the free exclusive mode, the commands stored in the command queue 512 may be processed in the memory controller 520 after exiting from the free exclusive mode. Through this, the host controller 510 may generate the response indicating the process completion of the commands stored in the command queue 512 and deliver the response to the host 102 after exiting from the free exclusive mode.

Through the operation of the host controller 510 according to the above-described operation 5104a, the host 102 providing commands in the free exclusive mode does not receive a response indicating the completion of operation in response to the commands provided the host 102 until the exit from the free exclusive mode. Accordingly, the host 102 delivers the commands to the host controller 510 up to the set number in the free exclusive mode, but determines that the commands exceeding the set number may not be processed in the memory system 110 and does not deliver the exceeding commands to the host controller 510. In other words, in the free exclusive mode, the host 102 delivers only the commands of the set number to the host controller 510, and then may not deliver the additional commands to the host controller 510. This means that the host controller 510 does not receive a request to process the first operation, for example, a request to process the read or write operation etc., in the free exclusive mode.

When the host controller 510 exits from the free exclusive mode and transmits to the host 102 the response indicating the process completion in response to the provided command, the host 102 may transmit additional commands exceeding the set number to the host controller 510.

On the other hand, in the above-described operation 5104a, the host controller 510 is also required to delay transmission of write data corresponding to write commands from the host 102 until the exit from the free exclusive mode.

To this end, the host controller 510 may selectively perform the following two operations.

First, the host controller 510 in the first operation delays a response indicating the transmission completion of write commands, which are transmitted from the host 102 and stored in the command queue 512, until the exit from the free exclusive mode through operation 5104b.

The operation 5104b is applied when the host 102 takes a lead on an operation of delivering the write data to the host controller 510. In other words, the host controller 510 operates in a manner to passively receive the write commands from the host 102, and then to passively receive the write data from the host 102. Here, in order to prevent loss of the write data, the host 102 checks whether the host controller 510 normally receives the write commands and then transmits the write data. Accordingly, even after receiving the write commands in the free exclusive mode, the host controller 510 may delay delivery of the write data from the host 102 until the exit from the free exclusive mode through the operation of delaying the delivery of the acknowledgement indicating that the write commands are normally received until the exit from the free exclusive mode.

Subsequently, in a second operation, the host controller 510 retrieves the write data stored in an internal memory (not shown) of the host 102 and corresponding to the provided write commands after the exit from the free exclusive mode through operation 5104c.

The operation 5104c is applied when the host controller 510 takes a lead on an operation of receiving the write data from to the host 102. In other words, the host controller 510 operates in a manner to passively receive the write commands from the host 102, and then to actively retrieve the write data stored in the internal memory of the host 102 and corresponding to the write commands. Here, the host 102 transmits the write commands to the host controller 510, and then stands by with the write data stored in the internal memory. The host controller 510 may determine when to retrieve the write data stored in the internal memory. Accordingly, the host controller 510 may delay the delivery of the write data from the host 102 in the free exclusive mode until the exit from the free exclusive mode by retrieving the write data from the internal memory of the host 102 at the exit from the free exclusive mode, regardless of a time of receiving the write command in the free exclusive mode.

For reference, as described above, it can be seen that operations 5104b and 5104c are operations that can be selected according to how the write data are processed between the host 102 and the memory controller 520. Accordingly, the host controller 510 may select any one among operations 5104b and 5104c and perform the selected operation.

Referring to FIG. 7, the memory controller 520 may check the value of the free exclusive flag of the free exclusive flag component 530 through operation 5204. Here, unlike the above-described host controller 510, the memory controller 520 may set the value of the free exclusive flag of the free exclusive flag component 530 through operations 5201, 5202 and 5203. In other words, as described with reference to operation 521 (described in FIG. 5), the memory controller 520 may set the value of the free exclusive flag of the free exclusive flag component 530 in response to a result obtained by checking a state of the nonvolatile memory device 150 through operations 5201, 5202 and 5203.

In addition, as described with reference to operation 522 (described in FIG. 5), the memory controller 520 exclusively uses the volatile memory device 144 in order to process a merge operation in the second operation performed between the memory controller 520 and the nonvolatile memory device 150 in the free exclusive mode, which may be known by checking the value of the free exclusive flag of the free exclusive flag component 530.

In detail, the reason why the memory controller 520 sets the value of the free exclusive flag of the free exclusive flag component 530 to indicate the free exclusive mode is for exclusively using the volatile memory device in order to process the merge operation in the second operation performed between the memory controller 502 and the nonvolatile memory device 150 in the free exclusive mode, as described with reference to operation 522. There may be three conditions for setting the value of the free exclusive flag of the free exclusive flag component 530 in the memory controller 520.

In a first condition (denoted as operation 5201), the memory controller 520 may check a ratio of free memory blocks among the memory blocks BLOCK<1> to BLOCK<6> included in the nonvolatile memory device 150, and may set the free exclusive flag of the free exclusive flag component 530 to indicate the free exclusive mode through operation 5201 when the checked result is equal to or smaller than a set ratio. When the checked result is greater than the set ratio, the free exclusive flag of the free exclusive flag component 530 may exit from the free exclusive mode and indicate that it is not in the free exclusive mode. In other words, in the first condition, when the number of the free memory blocks is remarkably small and the memory controller 520 determines a merge operation is needed, the free exclusive flag of the free exclusive component 530 is set to the free exclusive mode and allows the host controller 510 and the memory controller 520 to enter into the free exclusive mode.

In a second condition (denoted as operation 5202), when performing the merge operation, the memory controller 520 may check the number of the entire valid pages included in victim memory blocks among the memory blocks BLOCK<1> to BLOCK<6>. When the checked result is equal to or greater than the set number, the memory controller 520 may set the free exclusive flag of the free exclusive flag component 530 to indicate the free exclusive mode through operation 5202. When the checked result is smaller than the set number, the free exclusive flag of the free exclusive flag component 530 may exit from the free exclusive mode and indicate that it is not in the free exclusive mode. In other words, in the second condition, when the number of the entire valid pages included in the victim memory blocks is sufficiently large in the merge operation, the free exclusive flag may be set to the free exclusive mode and allows the host controller 510 and the memory controller 520 to enter into the free exclusive mode.

In the third condition (denoted as operation 5203), the memory controller 520 may set the free exclusive flag of the free exclusive flag component 530 to indicate the free exclusive mode, each time the merge operation is performed in the second operation with the nonvolatile memory device 150 through operation 5203. The memory controller 520 sets the free exclusive flag of the free exclusive flag component 530 to indicate that it is not in the free exclusive mode, each time an operation other than the merge operation is performed in the second operation with the nonvolatile memory device 150. In other words, when performing the merge operation in the third condition, the memory controller 520 does not perform additional determination as in the above-described second condition, but sets the free exclusive flag of the free exclusive flag component 530 to indicate the free exclusive mode so as to unconditionally enter into the free exclusive mode.

To summarize, the memory controller 520 may set the free exclusive flag of the free exclusive component 530 to indicate the free exclusive mode according to the result of checking the above-described three conditions, and allow the memory controller 520 and the host controller 510 to enter into the free exclusive mode. In this way, when entering into the free exclusive mode, as described in the above-described operation 522, the memory controller 520 performs the merge operation by exclusively using the volatile memory device 144. In this way, when the merge operation is continuously performed, until the above-described three conditions are satisfied, the memory controller 520 may set the free exclusive flag of the free exclusive flag component 530 to exit from the free exclusive mode and allows the memory controller 520 and the host controller 510 to exit from the free exclusive mode.

For reference, as described above, the memory controller 520 may include various conditions for setting the free exclusive flag of the free exclusive flag component 530, and under which condition the free exclusive flag is to be set may vary depending on design. In addition, in the above-described embodiment, when the memory controller 520 sets the free exclusive flag by own determination, only the operation is described according to the first condition that the ratio of the free memory blocks among the memory blocks BLOCK<1> to BLOCK<6> included in the nonvolatile memory device 150 is checked. However, the case is just one embodiment. In other words, the case where the memory controller 520 sets the free exclusive flag by own determination is not limited to only the operation according to the above-described first condition, and the memory controller 520 may select whether to set the free exclusive flag by own determination in various manners depending on design.

Furthermore, the memory controller 520 may check the value of the free exclusive flag of the free exclusive flag component 530 through the above-described operation 5204, and as the checked result, know whether or not from the memory system 110 is in the free exclusive mode.

In addition, the memory controller 520 may flush (in operation 5205) the data stored in the volatile memory device 144 to the nonvolatile memory device 150 in the free exclusive mode, which may be known from the checked result in operation 5204.

In such a case, the memory controller 520 will exclusively use the entire area of the volatile memory device 144 to perform the merge operation in the free exclusive mode.

Here, the operation in which the data stored in the volatile memory device 144 are flushed to the nonvolatile memory device 150 means that all the data stored in the volatile memory device 144 are copied and stored in an area set in the nonvolatile memory device 150. Accordingly, after the flush operation, the memory controller 520 may convert the data stored in the volatile memory device 144 to a discard state, and allow the entire area of the volatile memory device 144 to be exclusively used for performing the merge operation.

In addition, the memory controller 520 may convert, to the discard state through operation 5206, data updated to the nonvolatile memory device 150 from among the data stored in the volatile memory device 144 in the free exclusive mode, which may be known through the result from operation 5204.

In this case, the memory controller 520 may exclusively use a wider area than an area designated for a typical merge operation in the volatile memory device 144 to perform the merge operation during the entrance period to the free exclusive mode.

Here, as described in relation to FIG. 1, the volatile memory device 144 may be used for various purposes of use, for example, a write buffer/cache, a read buffer/cache, or a map buffer/cache, and thus it is typical to divide an internal storage space into various areas according to the purposes of use and manages the divided areas. Accordingly, for the volatile memory device 144 in a typical case, a partial area of the internal storage space may be designated in advance for the merge operation.

Here, the memory controller 520 according to an embodiment may convert, to the discard state, data updated to the nonvolatile memory device 150 from among the data stored in an area that is not designated in advance for the merge operation in the storage space of the volatile memory device 144 in response to the entrance into the free exclusive mode through the host controller 510. Accordingly, the memory controller 520 according an embodiment is capable of exclusively using a wider area than the area designated for the typical merge operation in the volatile memory device 144 to perform the merge operation when entering into the free exclusive mode.

In addition, the data updated to the nonvolatile memory device 150 among the data stored in the volatile memory device 144 means data already stored in the nonvolatile memory device 150 among the data stored in the volatile memory device 144 through an operation such as a checkpoint. Accordingly, it is possible that the memory controller 520 converts, to the discard state, the data updated to the nonvolatile memory device 150 among the data stored in the volatile memory device 144 in the free exclusive mode, and then uses a region corresponding to the discard state as a region for the merge operation.

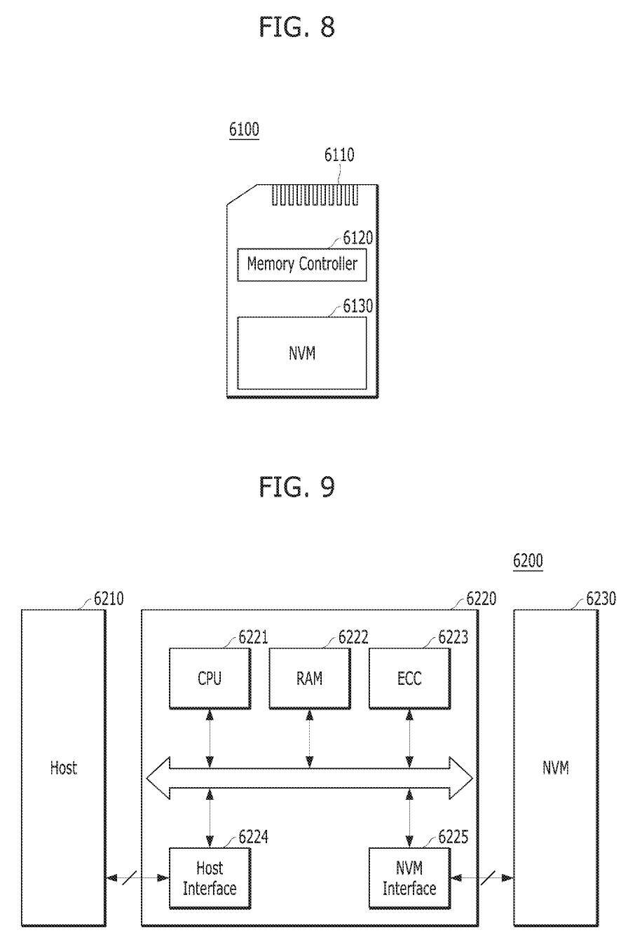

FIGS. 8 to 16 are diagrams schematically illustrating application examples of the data processing system of FIG. 1.

FIG. 8 is a diagram schematically illustrating another example of the data processing system including the memory system in accordance with the present embodiment. FIG. 8 schematically illustrates a memory card system to which the memory system in accordance with the present embodiment is applied.

Referring to FIG. 8, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 and 5, and the memory device 6130 may correspond to the memory device 150 of the memory system 110 described with reference to FIGS. 1 and 5.

Thus, the memory controller 6120 may include a RAM, a processing unit, a host interface, a memory interface and an error correction component. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 5.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 9 is a diagram schematically illustrating another example of the data processing system including the memory system in accordance with the present embodiment.

Referring to FIG. 9, the data processing system 6200 may include a memory device 6230 having one or more nonvolatile memories and a memory controller 6220 for controlling the memory device 6230. The data processing system 6200 illustrated in FIG. 9 may serve as a storage medium such as a memory card (CF, SD, micro-SD or the like) or USB device, as described with reference to FIG. 1. The memory device 6230 may correspond to the memory device 150 in the memory system 110 illustrated in FIGS. 1 and 5, and the memory controller 6220 may correspond to the controller 130 in the memory system 110 illustrated in FIGS. 1 and 5.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC component 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

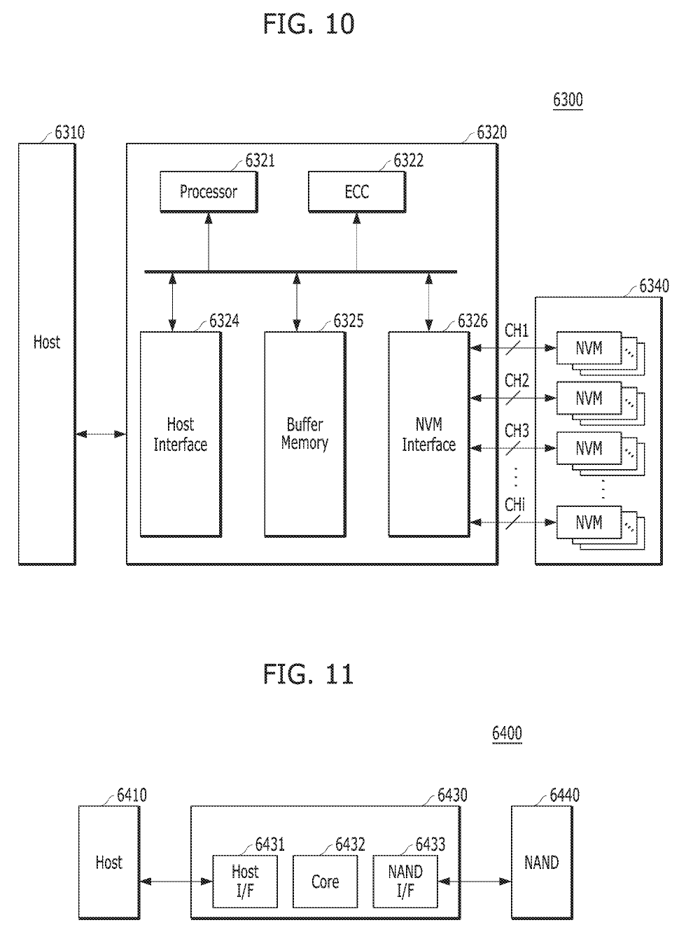

FIG. 10 is a diagram schematically illustrating another example of the data processing system including the memory system in accordance with the present embodiment. FIG. 10 schematically illustrates an SSD to which the memory system in accordance with the present embodiment is applied.

Referring to FIG. 10, the SSD 6300 may include a controller 6320 and a memory device 6340 including a plurality of nonvolatile memories. The controller 6320 may correspond to the controller 130 in the memory system 110 of FIGS. 1 and 5, and the memory device 6340 may correspond to the memory device 150 in the memory system of FIGS. 1 and 5.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 9 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIGS. 1 and 5 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the memory system in accordance with the present embodiment. FIG. 11 schematically illustrates an embedded Multi-Media Card (eMMC) to which the memory system in accordance with the present embodiment is applied.

Referring to FIG. 11, the eMMC 6400 may include a controller 6430 and a memory device 6440 embodied by one or more NAND flash memories. The controller 6430 may correspond to the controller 130 in the memory system 110 of FIGS. 1 and 5, and the memory device 6440 may correspond to the memory device 150 in the memory system 110 of FIGS. 1 and 5.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

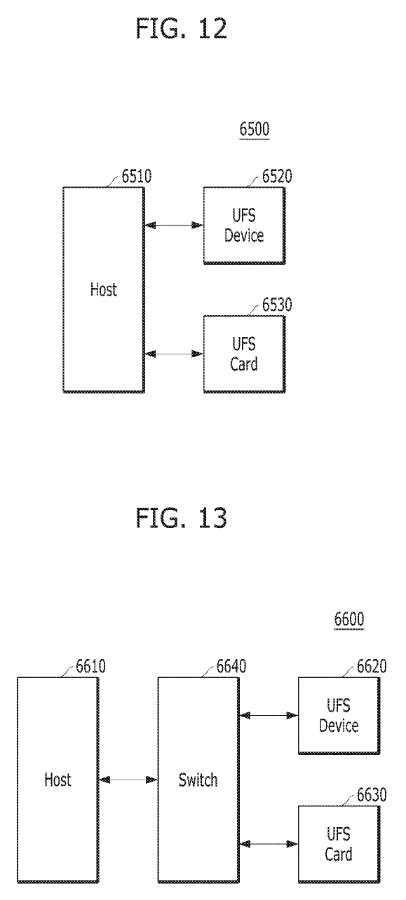

FIGS. 12 to 15 are diagrams schematically illustrating other examples of the data processing system including the memory system in accordance with the present embodiment. FIGS. 12 to 15 schematically illustrate UFS (Universal Flash Storage) systems to which the memory system in accordance with the present embodiment is applied.

Referring to FIGS. 12 to 15, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIGS. 1 and 5. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 9 to 11, and the UFS cards 6530, 6630, 6730 and 6830 may be embodied in the form of the memory card system 6100 described with reference to FIG. 8.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 12, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

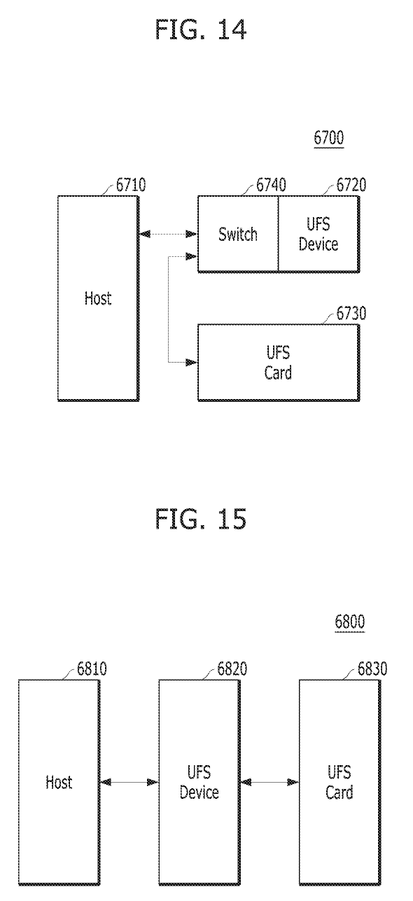

In the UFS system 6700 illustrated in FIG. 14, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

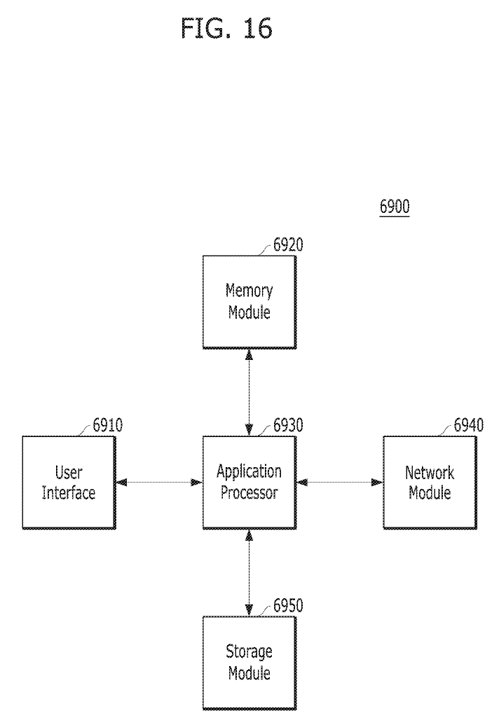

FIG. 16 is a diagram schematically illustrating another example of the data processing system including the memory system in accordance with an embodiment. FIG. 16 is a diagram schematically illustrating a user system to which the memory system in accordance with the present embodiment is applied.

Referring to FIG. 16, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIGS. 1 and 5. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 5 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

According to the present technology, performance of the merge operation may be maximized by allowing an exclusive use of the volatile memory device so as to perform the merge operation in the free exclusive mode.

Here, the entrance into and exit from the free exclusive mode is determined using the free exclusive flag, the value of which may be checked and set by the memory controller and only be checked by the host controller. Through this, the entrance into or exit from the free exclusive mode is enabled to be selected with reference to an operation of the memory controller, and a priority of the merge operation by the memory controller may be higher than that of a host-requested operation by the host controller.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a nonvolatile memory device comprising a plurality of memory blocks, each of which comprises a plurality of pages;
a volatile memory device configured to temporarily store data to be delivered between a host and the nonvolatile memory device;
a host controller configured to process a first operation with the host and delay the process of the first operation in a free exclusive mode according to a value of a free exclusive flag indicating the free exclusive mode; and
a memory controller configured to process a second operation with the nonvolatile memory device, set the value of the free exclusive flag according to a state of the nonvolatile memory device, and exclusively use the volatile memory device so as to process a merge operation in the second operation in the free exclusive mode.

2. The memory system of claim 1,
wherein the memory controller checks a ratio of free memory blocks among the memory blocks,
wherein the memory controller sets the free exclusive flag to indicate the free exclusive mode when a checked result is equal to or smaller than a set ratio, and
wherein the memory controller sets the free exclusive flag to indicate a mode other than the free exclusive mode when the checked result is greater than the set ratio.

3. The memory system of claim 1,
wherein the memory controller checks a number of entire valid pages included in victim memory blocks among the memory blocks when performing the merge operation,
wherein the memory controller sets the free exclusive flag to indicate the free exclusive mode when a checked result is equal to or smaller than a set number, and
wherein the memory controller sets the free exclusive flag to indicate a mode other than the free exclusive mode when the checked result is greater than the set number.

4. The memory system of claim 1,
wherein the memory controller sets the free exclusive flag to indicate the free exclusive mode each time the merge operation is performed, and
wherein the memory controller sets the free exclusive flag to indicate a mode other than the free exclusive mode each time an operation other than the merge operation is performed in the second operation.

5. The memory system of claim 1, wherein the host controller
notifies the host of a busy state in the free exclusive mode, and
notifies the host of a ready state in a mode other than the free exclusive mode.

6. The memory system of claim 1,
wherein the host controller comprises a command queue configured to store commands delivered from the host, and
wherein the host controller delays a process of the commands delivered from the host and stored in the command queue in the free exclusive mode.

7. The memory system of claim 6, wherein the host controller stores the commands delivered from the host in free exclusive mode in the command queue and then delivers, to the host, a response indicating process completion of the commands after exit from free exclusive mode by delaying delivering the stored commands to the memory controller until the exit from the free exclusive mode.

8. The memory system of claim 7, wherein the host controller
delays delivering, to the host, a response indicating transmission completion of write commands until the exit from the free exclusive mode, or
retrieves write data stored in an internal memory of the host in response to the write commands after the exit from the free exclusive mode,
so as to delay transmission of the write data corresponding to each of the write commands from the host among the commands stored in the command queue in the free exclusive mode until the exit from the free exclusive mode.

9. The memory system of claim 1, wherein the memory controller flushes the data stored in the volatile memory device to the nonvolatile memory device in the free exclusive mode, and then exclusively uses the volatile memory device so as to perform the merge operation for the nonvolatile memory device in the free exclusive mode.

10. The memory system of claim 1,
wherein the memory controller converts, to a discard state, data updated to the nonvolatile memory device among data stored in the volatile memory device in the free exclusive mode, and
wherein the memory controller exclusively uses the volatile memory device so as to perform the merge operation for the nonvolatile memory device in the free exclusive mode.

11. An operation method of a memory system including a nonvolatile memory device comprising a plurality of memory blocks, each of which comprises a plurality of pages, a volatile memory device configured to temporarily store data to be delivered between a host and the nonvolatile memory device, a host controller configured to process a first operation with the host, and a memory controller configured to process a second operation with the nonvolatile memory device, the operation method comprising:
a delay operation of checking a value of a free exclusive flag indicating a free exclusive mode through the host controller and then delaying the process of the first operation through the host controller in the free exclusive mode according to the value of the free exclusive flag;
a setting operation of setting the value of the free exclusive flag through the memory controller according to a state of the nonvolatile memory device; and
a using operation of exclusively using the volatile memory device so as to process a merge operation in the second operation through the memory controller in the free exclusive mode.

12. The operation method of claim 11, wherein the setting operation comprises:
a first checking operation of checking a ratio of free memory blocks among the memory blocks through the memory controller;
an operation of setting the free exclusive flag to indicate the free exclusive mode through the memory controller when a checked result is equal to or smaller than a set ratio; and
an operation of setting the free exclusive flag to indicate a mode other than the free exclusive mode through the memory controller when the checked result is greater than the set ratio.

13. The operation method of claim 11, wherein the setting operation comprises:
a second checking operation of checking a number of entire valid pages comprised in victim memory blocks among the memory blocks when the merge operation is performed through the memory controller;
an operation of setting the free exclusive flag to indicate the free exclusive mode through the memory controller when a checked result is equal to or greater than a set number; and
an operation of setting the free exclusive flag to indicate a mode other than the free exclusive mode through the memory controller when the checked result is smaller than the set number.

14. The operation method of claim 11, wherein the setting operation comprises:
an operation of setting the free exclusive flag to indicate the free exclusive mode, each time the merge operation is performed through the memory controller; and
an operation of setting the free exclusive flag to indicate a mode other than the free exclusive mode, each time an operation other than the merge operation is performed in the second operation through the memory controller.

15. The operation method of claim 11, wherein the delaying operation comprises:
a third checking operation of checking the value of the free exclusive flag through the host controller;
an operation of notifying, by the host controller, the host that the memory system is busy in the free exclusive mode; and
an operation of notifying, by the host controller, the host that the memory system is ready in the free exclusive mode.

16. The operation method of claim 11, wherein the delaying operation comprises:
a fourth checking operation of checking the value of the free exclusive flag through the host controller comprising a command queue configured to store commands delivered from the host; and
a command delaying operation of delaying a process of the host controller for the commands delivered from the host and stored in the command queue in the free exclusive mode.

17. The operation method of claim 16, wherein the command delaying operation comprises:
an operation of storing, by the host controller, the commands delivered from the host in the command queue therein in the free exclusive mode; and
an operation of delivering, from the host controller to the host, a response indicating process completion of the commands after an exit from the free exclusive mode by delaying, by the host controller, delivering the commands stored in the command queue to the memory controller until the exit from the free exclusive mode.

18. The operation method of claim 17, wherein the command delaying operation further comprises:
an operation of delaying delivering, to the host from the host controller, a response indicating transmission completion of write commands until the exit from the free exclusive mode exit time; or
an operation of retrieving, from the host controller, write data stored in an internal memory of the host in response to the write commands after the exit from the free exclusive mode,
so as to delay transmission, from the host to the host controller, of the write data corresponding to each of the write commands among the commands stored in the command queue in the free exclusive mode until the exit from the free exclusive mode through the storing operation.

19. The operation method of claim 11, wherein the using operation comprises:
a fifth checking operation of checking the value of the free exclusive flag through the memory controller;
an operation of flushing the data stored in the volatile memory device to the nonvolatile memory device through the memory controller in the free exclusive mode; and
an operation of exclusively using the volatile memory device so as to perform the merge operation for the nonvolatile memory device in the free exclusive mode.

20. The operation method of claim 11, wherein the using operation comprises:
a sixth checking operation of checking the value of the free exclusive flag through the memory controller;
an operation of converting, to a discard state, data updated to the nonvolatile memory device among the data stored in the volatile memory device through the memory controller in the free exclusive mode which is knowable from the sixth checking operation; and
an operation of exclusively using the volatile memory device so as to perform the merge operation for the nonvolatile memory device in the free exclusive mode.
